(19) United States
(12) Patent Application Publication
(10) Pub. No.: US 2004/0246864 A1
(43) Pub. Date: Dec. 9, 2004

(54) Apparatus and method for controlling recording or reproduction, apparatus for performing recording or reproduction, and information recording medium identification apparatus

(76) Inventors: Isao Kobayashi, Osaka (JP); Harumitsu Miyashita, Nara (JP); Mamoru Shoji, Osaka (JP); Takashi Ishida, Kyoto (JP)

Correspondence Address: MARK D. SARALINO (GENERAL), RENNER, OTTO, BOISELLE & SKLAR, LLP, 1621 EUCLID AVENUE, NINETEENTH FLOOR, CLEVELAND, OH, 44115-2191, US

(21) Appl. No.: 10/832,708

(22) Filed: Apr. 27, 2004

(30) Foreign Application Priority Data
Apr. 28, 2003 (JP) 2003-124048

(51) Int. Cl. G11B 5/09; G11B 7/00

(52) U.S. Cl. 369/59.22; 369/47.28; 369/53.31

(57) ABSTRACT

An apparatus for controlling recording or reproduction includes a maximum likelihood decoding section for performing maximum likelihood decoding of a digital signal having a waveform thereof rectified and generating a first binary signal representing a result of the maximum likelihood decoding; a reliability calculating section for calculating a reliability of the result of the maximum likelihood decoding based on the digital signal having the waveform thereof rectified and the first binary signal; a jitter detection section for detecting jitter; and a parameter setting section for setting a value of a prescribed parameter which is a recording parameter or a reproduction parameter. The parameter setting section calculates a first optimum value of the prescribed parameter based on the reliablilty, calculates a second optimum value of the prescribed parameter based on the jitter, and sets the value of the prescribed parameter between the first optimum value and the second optimum value inclusive.

This non-provisional application claims priority under 35 U.S.C., §119(a), on Patent Application No. 2003-124048filed in Japan on Apr. 28, 2003, the entire contents of which are hereby incorporated by reference.

### BACKGROUND OF THE INVENTION

1. Field of the Invention

The present invention relates to an apparatus and method for controlling information recording on or reproduction from an information recording medium, an apparatus for performing recording or reproduction, and an information recording medium identification apparatus.

2. Description of the Related Art

When recording or reproduction of original digital information on or from optical discs by irradiation of laser light, optical disc drives and recording mediums such as the optical discs have individual differences. Therefore, the quality of the signal reproduced, the setting of recording pulses, and the like may be different. In order to avoid reduction in the reliability due to such individual differences, a correction operation is performed when, for example, the recording medium is mounted. A correction operation is an operation for optimizing the setting of characteristics of the reproduction system, the recording power, the shape of the recording pulse, or the like, in order to guarantee the reliability of user data.

A general information reproduction apparatus includes a PLL circuit for extracting clock information included in a reproduction signal and identifying the original digital information based on the clock information extracted.

FIG. 1 shows a structure of an optical disc drive. Light reflected by an optical disc 1 is converted into a reproduction signal by an optical head 2. The reproduction signal is shape-rectified by a waveform equalizer 3. The resultant reproduction signal is binarized by a comparator 4. Usually, the threshold of the comparator 4 is feedback-controlled such that an accumulation result of binary signal outputs is 0. A phase comparator 5 obtains phase errors between the binary signal outputs and the reproduction clock signals. The phase errors are averaged by an LPF 6, and a control voltage of a VCO 7 is determined based on the processing result. The phase comparator 5 is feedback-controlled such that the phase errors output by the phase comparator 5 are always 0.

In the above-mentioned binary system, it is determined whether or not the binary signal and the reproduction clock signal are synchronized with each other depending on whether or not a phase error between an output from the comparator 4 and the reproduction clock signal is within the window width for detection (also referred to as the “window width”). When the phase error exceeds the window width due to, for example, inter-symbol interference of the reproduction signal, optical aberration, distortion of the recording mark, circuit noise, or control error of the PLL circuit, an error occurs. Such an error between the output from the comparator 4 (detected pulse) and the reproduction clock signal is referred to as the “jitter”. Assuming that the distribution of the jitter is a normal distribution having an average value of 0, the probability that an error occurs, Pj (σ/Tw), is represented by expressions 1 and 2.

$$\begin{matrix}Pj ( σ / Tw ) = 2 erfc ( \frac{Tw / 2}{σ} ) & expression 1 \\ erfc ( z ) = \frac{1}{\sqrt{2 π}} {\int }_{z}^{∞} exp ( - \frac{{u}^{2}}{2} ) ⅆ u & expression 2\end{matrix}$$

Here, σ is the standard deviation of the jitter having the normal distribution, and Tw is the window width.

Namely, the signal quality can be evaluated by σ/Tw, and the error rate can be predicted theoretically. In actuality, the jitter of the reproduction signal can be detected by a TIA (time interval analyzer). Therefore, the jitter is widely used as an index of the reproduction signal quality. A large number of methods and apparatuses, for performing recording and reproduction by performing optimum control such that the jitter is minimum, have been proposed (for example, see, Japanese Laid-Open Publication No. 2001-52351).

In a method for setting a servo control parameter or a recording parameter, such that the jitter is minimum based on (i) the servo conditions (for example, focal point), (ii) output conditions of recording pulses, or the like, there are cases where the probability that the error occurs is not minimum in a system using the maximum likelihood decoding method. More specifically, there are (i) a state where the jitter of the reproduction signal is minimum by the optimum reproduction clock being extracted by the PLL circuit; and (ii) the error generation probability is minimum even though the reproduction clock is not optimum. As a result, the evaluation result of the reproduction signal may possibly be different depending on the conditions under which the recording or reproduction is performed on or from the information recording medium.

### SUMMARY OF THE INVENTION

According to one aspect of the invention, an apparatus for controlling recording or reproduction includes a rectification section for receiving a digital signal generated based on an analog signal representing information reproduced from an information recording medium and a clock signal, and rectifying a waveform of the digital signal; a maximum likelihood decoding section for performing maximum likelihood decoding of the digital signal having the waveform thereof rectified and generating a first binary signal representing a result of the maximum likelihood decoding; a reliability calculating section for calculating a reliability of the result of the maximum likelihood decoding based on the digital signal having the waveform thereof rectified and the first binary signal; a clock signal generation section for receiving a second binary signal generated by binarizing the analog signal based on a prescribed threshold value, detecting a phase error between the second binary signal and the clock signal, and adjusting a phase of the clock signal based on the detected phase error; a jitter detection section for detecting jitter based on the detected phase error; and a parameter setting section for setting a value of a prescribed parameter which is one of a recording parameter and a reproduction parameter. The parameter setting section calculates a first optimum value of the prescribed parameter based on the reliability, calculates a second optimum value of the prescribed parameter based on the jitter, and sets the value of the prescribed parameter between the first optimum value and the second optimum value inclusive.

In one embodiment of the invention, the prescribed parameter is a parameter used for performing at least one of tilt control, tracking control, focusing control, spherical aberration correction control, frequency characteristic control and laser power control.

In one embodiment of the invention, the parameter setting section sets the value of the prescribed parameter at an average value of the first optimum value and the second optimum value.

In one embodiment of the invention, the parameter setting section sets the value of the prescribed parameter at a value at which a difference from the first optimum value and a difference from the second optimum value have a prescribed ratio.

In one embodiment of the invention, the parameter setting section sets the value of the prescribed parameter, such that the value of the prescribed parameter is closer to an optimum value calculated based on either the reliability or the jitter, which is changed at a larger change ratio when the value of the prescribed parameter is changed, than to an optimum value calculated based on either the reliability or the jitter, which is changed at a smaller change ratio when the value of the prescribed parameter is changed.

In one embodiment of the invention, when a value of the jitter, which is obtained when the value of the prescribed parameter is the first optimum value, fulfills a prescribed condition, the parameter setting section sets the value of the prescribed parameter at the first optimum value.

In one embodiment of the invention, when a value of the reliability, which is obtained when the value of the prescribed parameter is the second optimum value, fulfills a prescribed condition, the parameter setting section sets the value of the prescribed parameter at the second optimum value.

In one embodiment of the invention, the maximum likelihood decoding section performs maximum likelihood decoding using a state transition rule which is defined by a recording symbol having a minimum polarity inversion interval of 2 and an equalization system PR (C0,C1,C1,C0).

In one embodiment of the invention, the maximum likelihood decoding section performs maximum likelihood decoding using a state transition rule which is defined by a recording symbol having a minimum polarity inversion interval of 3 and an equalization system PR (C0,C1,C1,C0).

In one embodiment of the invention, the reliability calculation section calculates the reliability based on the digital signal corresponding to each of a start and an end of a recording mark formed on the information recording medium and the first binary signal.

In one embodiment of the invention, the first optimum value is a value of the prescribed parameter when the reliability is highest.

In one embodiment of the invention, the parameter setting section calculates the first optimum value based on one of an accumulation value and an average value of the reliability.

According to another aspect of the invention, an apparatus for controlling recording or reproduction includes a parameter setting section for setting a value of a prescribed parameter which is one of a recording parameter and a reproduction parameter; a first calculation section for receiving a digital signal generated based on an analog signal representing information reproduced from an information recording medium, and calculating a first index used for setting the value of the prescribed parameter based on the digital signal; and a second calculation section for receiving a binary signal generated by binarizing the analog signal based on a prescribed threshold value, and calculating a second index used for setting the value of the prescribed parameter based on the binary signal. The parameter setting section calculates a first optimum value of the prescribed parameter based on the first index, calculates a second optimum value of the prescribed parameter based on the second index, and sets the value of the prescribed parameter between the first optimum value and the second optimum value inclusive.

According to still another aspect of the invention, an apparatus for performing recording or reproduction includes a reproduction section for generating a digital signal based on an analog signal representing information reproduced from an information recording medium and a clock signal; a rectification section for rectifying a waveform of the digital signal; a maximum likelihood decoding section for performing maximum likelihood decoding of the digital signal having the waveform thereof rectified and generating a first binary signal representing a result of the maximum likelihood decoding; a reliability calculating section for calculating a reliability of the result of the maximum likelihood decoding based on the digital signal having the waveform thereof rectified and the first binary signal; a clock signal generation section for receiving a second binary signal generated by binarizing the analog signal based on a prescribed threshold value, detecting a phase error between the second binary signal and the clock signal, and adjusting a phase of the clock signal based on the detected phase error; a jitter detection section for detecting jitter based on the detected phase error; a parameter setting section for setting a value of a prescribed parameter which is one of a recording parameter and a reproduction parameter: and a head section for performing at least one of recording and reproduction of information based on the prescribed parameter. The parameter setting section calculates a first optimum value of the prescribed parameter based on the reliability, calculates a second optimum value of the prescribed parameter based on the jitter, and sets the value of the prescribed parameter between the first optimum value and the second optimum value inclusive.

According to still another aspect of the invention, an information recording medium identification apparatus includes a rectification section for receiving a digital signal generated based on an analog signal representing information reproduced from an information recording medium and a clock signal, and rectifying a waveform of the digital signal; a maximum likelihood decoding section for performing maximum likelihood decoding of the digital signal having the waveform thereof rectified and generating a first binary signal representing a result of the maximum likelihood decoding; a reliability calculating section for calculating a reliability of the result of the maximum likelihood decoding based on the digital signal having the waveform thereof rectified and the first binary signal; a clock signal generation section for receiving a second binary signal generated by binarizing the analog signal based on a prescribed threshold value, detecting a phase error between the second binary signal and the clock signal, and adjusting a phase of the clock signal based on the detected phase error; a jitter detection section for detecting jitter based on the detected phase error; a parameter setting section for setting a value of a prescribed parameter which is one of a recording parameter and a reproduction parameter, wherein the parameter setting section calculates a first optimum value of the prescribed parameter based on the reliability, calculates a second optimum value of the prescribed parameter based on the jitter, and sets the value of the prescribed parameter between the first optimum value and the second optimum value inclusive; and a determination section for determining whether or not the value of the reliability and the value of the jitter corresponding to the set value of the prescribed parameter fulfill a prescribed condition.

According to still another aspect of the invention, a method for controlling recording or reproduction includes the steps of receiving a digital signal generated based on an analog signal representing information reproduced from an information recording medium and a clock signal, and rectifying a waveform of the digital signal; performing maximum likelihood decoding of the digital signal having the waveform thereof rectified and generating a first binary signal representing a result of the maximum likelihood decoding; calculating a reliability of the result of the maximum likelihood decoding based on the digital signal having the waveform thereof rectified and the first binary signal; receiving a second binary signal generated by binarizing the analog signal based on a prescribed threshold value, detecting a phase error between the second binary signal and the clock signal, and adjusting a phase of the clock signal based on the detected phase error; detecting jitter based on the detected phase error; and setting a value of a prescribed parameter which is one of a recording parameter and a reproduction parameter. The step of setting the value of the prescribed parameter includes the steps of calculating a first optimum value of the prescribed parameter based on the reliability, calculating a second optimum value of the prescribed parameter based on the jitter, and setting the value of the prescribed parameter between the first optimum value and the second optimum value inclusive.

In one embodiment of the invention, the prescribed parameter is a parameter used for performing at least one of tilt control, tracking control, focusing control, spherical aberration correction control, frequency characteristic control and laser power control.

In one embodiment of the invention, the step of setting the value of the prescribed parameter includes the step of setting the value of the prescribed parameter at an average value of the first optimum value and the second optimum value.

In one embodiment of the invention, the step of setting the value of the prescribed parameter includes the step of setting the value of the prescribed parameter at a value at which a difference from the first optimum value and a difference from the second optimum value have a prescribed ratio.

In one embodiment of the invention, the step of setting the value of the prescribed parameter includes the step of setting the value of the prescribed parameter, such that the value of the prescribed parameter is closer to an optimum value calculated based on either the reliability or the jitter, which is changed at a larger change ratio when the value of the prescribed parameter is changed, than to an optimum value calculated based on either the reliability or the jitter, which is changed at a smaller change ratio when the value of the prescribed parameter is changed.

In one embodiment of the invention, the step of setting the value of the prescribed parameter includes the step of, when a value of the jitter, which is obtained when the value of the prescribed parameter is the first optimum value, fulfills a prescribed condition, setting the value of the prescribed parameter at the first optimum value.

In one embodiment of the invention, the step of setting the value of the prescribed parameter includes the step of, when a value of the reliability, which is obtained when the value of the prescribed parameter is the second optimum value, fulfills a prescribed condition, setting the value of the prescribed parameter at the second optimum value.

According to an apparatus and method of the present invention, a first optimum value of the recording or reproduction parameter is calculated based on the reliability of the maximum likelihood decoding, and a second optimum value of the recording or reproduction parameter is calculated based on the jitter, and the value of the recording or reproduction parameter is set at a value between the first optimum value and the second optimum value inclusive. Thus, a recording or reproduction parameter which is optimum to both the maximum likelihood decoding and jitter can be derived.

According to an apparatus and method of the present invention, the recording or reproduction parameter is set such that the jitter is minimum. In addition, the recording or reproduction parameter at which the error generation probability is minimum when performing decoding using the maximum likelihood decoding method is set. A recording or reproduction parameter X1 and a recording or reproduction parameters X2 which are optimum for two types of evaluation indices are obtained, and an average value of the recording or reproduction parameters X1 and X2 is calculated. Alternatively, a recording or reproduction parameter, at which a difference from the parameter X1 and a difference from the parameter X2 have a ratio of a:b (a and b are each an integer), may be calculated. Thus, the recording or reproduction parameter which is optimum for the entire system can be derived. The reproduction parameter control is, for example, servo control or frequency characteristic control of a waveform equalizer. The recording parameter control is, for example, recording power control.

As described above, the present invention is especially useful for an apparatus and method for controlling recording or reproduction, an apparatus fox performing recording or reproduction, and an information recording medium identification apparatus.

Thus, the invention described herein makes possible the advantages of providing a method and an apparatus for controlling recording or reproduction, by which a parameter which is suitable to indices of both the reliability of the maximum likelihood decoding result and the jitter is set; an apparatus for performing recording or reproduction, by which a parameter which is suitable to indices of both of the reliability of the maximum likelihood decoding result and the jitter is set; and an information recording medium identification apparatus for identifying an information recording medium which fulfills a prescribed condition.

These and other advantages of the present invention will become apparent to those skilled in the art upon reading and understanding the following detailed description with reference to the accompanying figures.

### BRIEF DESCRIPTION OF THE DRAWINGS

FIG. 1 shows a structure of an optical disc drive having a PLL circuit;

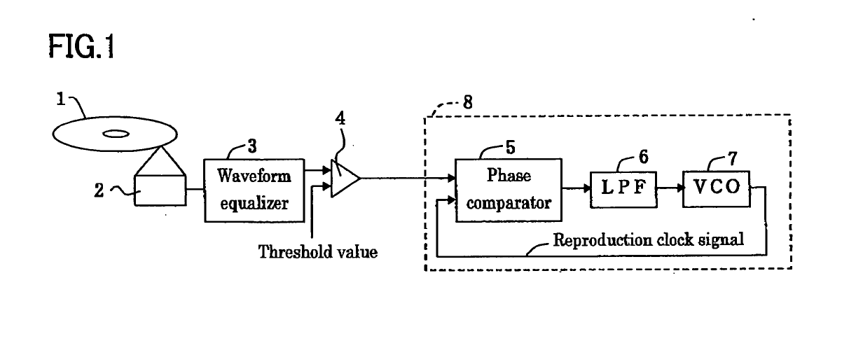

FIG. 2 is a graph illustrating a jitter distribution in which the jitter value is not changed even when the distribution to partially deviated from the normal distribution;

FIG. 3 shows a state transition rule defined by a minimum polarity inversion interval of 2 and an equalization system of PR (1,2,2,1) used in the present invention;

FIG. 4 shows a trellis diagram and a state transition rule defined by a minimum polarity inversion interval of 2 and an equalization system of PR (1,2,2,1) used in the present invention;

FIGS. 5A and 5B each schematically show a distribution of Pa-Pb representing a reliability of the decoding results;

FIG. 6 shows a phase error between the binary signal of the reproduction signal and the reproduction clock signal;

FIG. 7 shows an optimum range for tilt control according to the present invention;

FIG. 8 shows an optimum range for tracking control according to the present invention;

FIG. 9 shows an optimum range for focusing control according to the present invention;

FIG. 10 shows an optimum range for spherical aberration correction control according to the present invention;

FIG. 11 shows an optimum range for frequency characteristic control according to the present invention;

FIG. 12 shows an optimum range for laser driving control according to the present invention;

FIG. 13 is a flowchart illustrating a method for calculating an optimum position according to the present invention;

FIG. 14 shows standardization of index values according to the present invention;

FIG. 15 is a flowchart illustrating another method for calculating an optimum position according to the present invention;

FIG. 16 is a flowchart illustrating still another method for calculating an optimum position according to the present invention;

FIG. 17 is a block diagram of an apparatus for performing recording or reproduction according to the present invention;

FIG. 18 is a flowchart illustrating a method for evaluating characteristics of an information recording medium according to the present invention; and

FIG. 19 is a block diagram of an information recording medium identification apparatus for evaluating characteristics of an information recording medium according to the present invention.

### DESCRIPTION OF THE PREFERRED EMBODIMENTS

Hereinafter, the present invention will be described by way of illustrative examples with reference to the accompanying drawings.

First, a method for evaluating the quality of a reproduction signal obtained by using a maximum likelihood decoding method will be described. In the following example, a recording symbol having a minimum polarity inversion interval of 2 is used, and the waveform of the signal is rectified such that the frequency characteristic of the signal at the time of recording and reproduction matches PR (1, 2, 2, 1).

Where the instant recording symbol is bₖ, the immediately previous recording signal is bₖ₋₁, the recording signal two times previous is bₖ₋₂, and the recording signal three times previous is bₖ₋₃, an ideal output value Levelᵥ matching PR (1,2,2,1) is represented by expression 3.

Levelᵥ=bₖ₋₃+2bₖ₋₂+2bₖ₋₁+bₖ expression 3,

where k is an integer representing the time, and v is an integer of 0 through 6.

Where the state at time k is S(bₖ₋₂, bₖ₋₁, bₖ) the state transition table (Table 1) is obtained.

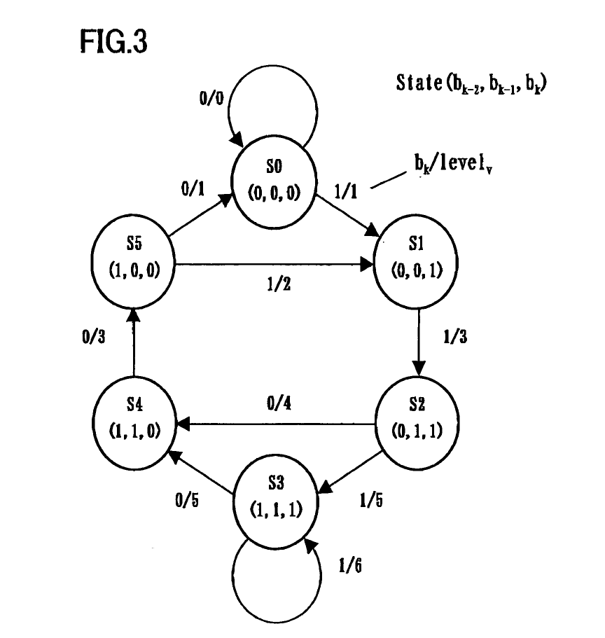

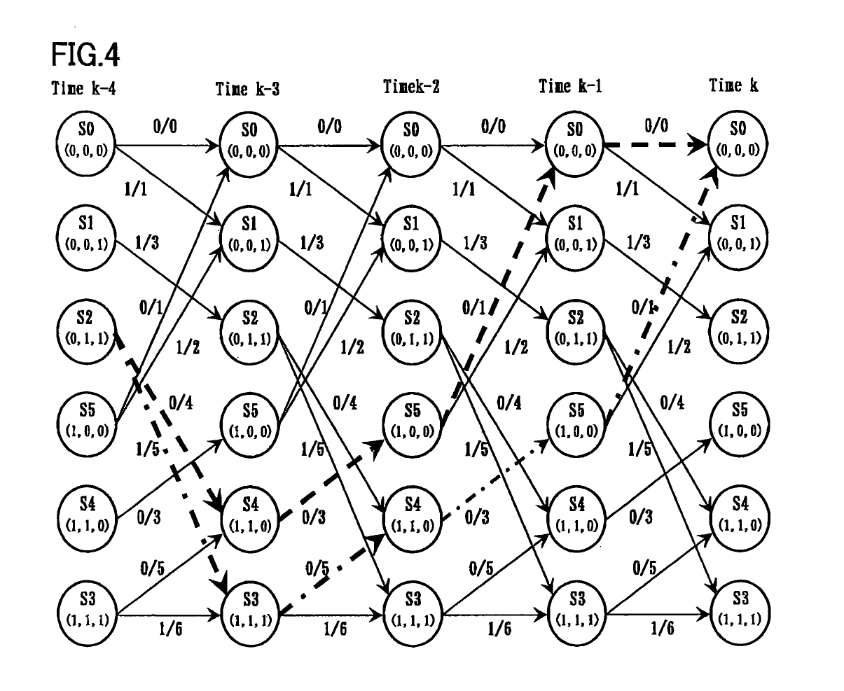

TABLE 1
State transitions based on a combination of a
recording symbol having a minimum polarity inversion interval
of 2T and the equalization system of PR (1, 2, 2, 1)

| State at time k-1 | State at time k | |
|---|---|---|
| S(bₖ₋₃, bₖ₋₂, bₖ₋₁) | S(bₖ₋₂, bₖ₋₁, bₖ) | Bₖ/Levelᵥ |
| S(0, 0, 0) | S(0, 0, 0) | 0/0 |
| S(0, 0, 0) | S(0, 0, 1) | 1/1 |
| S(0, 0, 1) | S(0, 1, 1) | 1/3 |
| S(0, 1, 1) | S(1, 1, 0) | 0/4 |
| S(0, 1, 1) | S(1, 1, 1) | 1/5 |
| S(1, 0, 0) | S(0, 0, 0) | 0/1 |
| S(1, 0, 0) | S(0, 0, 1) | 1/2 |
| S(1, 1, 0) | S(1, 0, 0) | 0/3 |
| S(1, 1, 1) | S(1, 1, 0) | 0/5 |
| S(1, 1, 1) | S(1, 1, 1) | 1/6 |

Where, for simplicity, state S(0,0,0)ₖ at time k is S0ₖ, state S(0,0,1)ₖ at time k is S1ₖ, state S(0,1,1))ₖ at time k is S2ₖ, state S(1,1,1)ₖ at time k is S3ₖ, state S(1,1,0)ₖ at time k is S4ₖ, and state S(1,0,0)ₖ at time k is S5ₖ, the state transition diagram shown in FIG. 3 is obtained. The state transition diagram shown in FIG. 3 represents the state transition rule defined by the minimum polarity inversion interval of 2 and the equalization system of PR (1,2,2,1). By developing this state transition diagram along the time axis, the trellis diagram shown in FIG. 4 is obtained. Now, state S0ₖ at time k and state S0ₖ₋₄ at time k-4 will be discussed. FIG. 4 shows two states transition paths which can be present between state S0ₖ and state S0ₖ₋₄. Where one of such state transition paths is path A, path A follows states S2ₖ₋₄, S4ₖ₋₃, S5ₖ₋₂. S0ₖ₋₁ and S0ₖ. Where the other one of such state transition paths is path B, path B follows states S2ₖ₋₄, S3ₖ₋₃, S4ₖ₋₂, S5ₖ₋₁ and S0ₖ. Here, the maximum likelihood decoding result from time k-6 to time k is (Cₖ₋₆, Cₖ₋₅, Cₖ₋₄, Cₖ₋₃, Cₖ₋₂. Cₖ₋₁, Cₖ). When the decoding result of (Cₖ₋₆, Cₖ₋₅, Cₖ₋₄, Cₖ₋₃, Cₖ₋₂, Cₖ₋₁, Cₖ)=(0,1,1,x,0,0,0) is obtained where x is 0 or 1, the state transition path A or B is estimated to have the maximum likelihood. Path A and path B have the same level of likelihood that the state at time k-4 is state S2ₖ₋₄. Therefore, which of path A or path B has the maximum likelihood can be determined by finding an accumulation value of squares of the differences between (i) the value from reproduction signal yₖ₋₃ to reproduction signal yₖ from time k-3 to time k and (ii) the expected value of path A or the expected value of path B (I.e., an Euclid distance between the output data from the digital filter and the target value used for maximum likelihood decoding). Where the accumulation value of squares of the differences between (i) the value from reproduction signal yₖ₋₃ to reproduction signal yₖ from time k-3 to time k and (ii) the expected value of path A is Pa, Pa is represented by expression 4. Where the accumulation value of squares of the differences between (i) the value from reproduction signal yₖ₋₃ to reproduction signal yₖ from time k-3 to time k and (i) the expected value of path B is Pb, Pb is represented by expression 5.

Pa=(yₖ₋₃-4)²+(yₖ₋₂-3)²+(yₖ₋₁-1)²+(yₖ-0)² expression 4

Pb=(yₖ₋₃-5)²+(yₖ₋₂-5)²+(yₖ₋₁-3)²+(yₖ-1)² expression 5

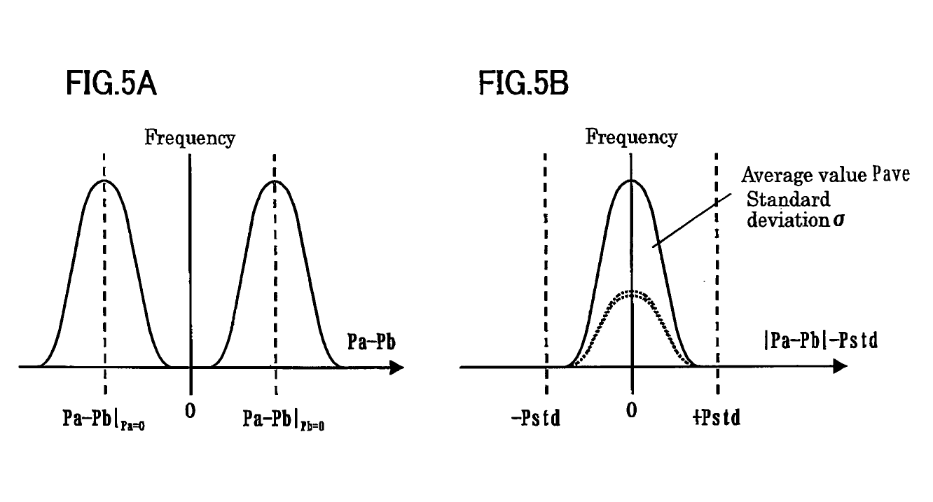

The difference between Pa and Pb (i.e., Pa-Pb), which represents the reliability of the maximum likelihood decoding result, has the following meaning. A maximum likelihood decoding section selects path A with confidence when Pa<<Pb, and selects path B with confidence when Pa>>Pb. When Pa-Pb, there is no abnormality found in selecting either path A or path B. The probability that the decoding result is correct is 50%. By finding Pa-Pb from the decoding result for a prescribed time or a prescribed number of times, distributions of Pa-Pb as shown in FIGS. 5A and 5B is obtained.

FIG. 5A shows a distribution of Pa-Pb when noise is superimposed on the reproduction signal. The distribution has two peaks of frequency. One peak is when Pa-0, and the other peak is when Pb=0. Here, the value of Pa-Pb when Pa=0 is represented as −Pstd, and the value of Pa-Pb when Pb=0 is represented as Pstd. The absolute value of Pa-Pb is calculated, and |Pa-Pb|−Pstd is obtained.

FIG. 5B shows a distribution of |Pa-Pb|−Pstd. The standard deviation a and the average value Pave of the distribution shown in FIG. 5B are obtained. Where the distribution shown in FIG. 5B is a normal distribution and, for example, the state where the value of the reliability of decoding result |Pa-Pb| is −Pstd or less is the state where an error has occurred, the error probability P (σ, Pave) is represented by expression 6 using σ and Pave. The error probability is the probability at which the post-decoding reproduction signal is incorrect.

$$P ( σ , Pave ) = erfc ( \frac{Pstd + Pave}{σ} ) \qquad expression 6$$

An error probability of the binary signal representing the maximum likelihood decoding result can be predicted from the average value Pave and the standard deviation a which are calculated from the distribution of Pa-Pb. Namely, the average value Pave and the standard deviation a can be an index of the quality of the reproduction signal. In the above example, the distribution of |Pa-Pb| is assumed to be a normal distribution. In the case where the distribution is not a normal distribution, the number of times that the value of |Pa-Pb|−Pstd becomes less than or equal to a prescribed reference value is counted. The obtained number can be an index of the quality of the reproduction signal.

In the case of the state transition rule defined by the recording symbol having a minimum polarity inversion interval of 2 and the equalization system PR (1,2,2,1), there are two possible state transition paths in the following number of state transition patterns: 8 patterns from time k-4 to time k; 8 patterns from time k-5 to time k; and 8 patterns from time k-6 to time k. In a wider range of detection, the number of such patterns increases necessarily. It is preferable to use the reliability Pa-Pb as the index of the quality of the reproduction signal. In this case, it is not necessary to detect all the patterns; by only detecting the patterns having a high error probability, such a detection result can be used as the index which is correlated with the error probability. A pattern having a high error probability is a pattern having a small value of reliability Pa-Pb. In this example, such a pattern indicates a start or an end of a recording mark formed on the information recording medium, and there are 8 such patterns, where Pa-Pb=±10. These 8patterns and Pa-Pb are summarized in Table 2.

TABLE 2
Patterns in which there can be two shortest state
transition paths

Reliability of decoding result (Pa-Pb)

| State transition | Pa = 0 | Pb = 0 |
|---|---|---|
| S2ₖ₋₄ → S0ₖ | −10 | +10 |
| S3ₖ₋₄ → S0ₖ | −10 | +10 |
| S2ₖ₋₄ → S1ₖ | −10 | +10 |
| S3ₖ₋₄ → S1ₖ | −10 | +10 |
| S0ₖ₋₄ → S4ₖ | −10 | +10 |
| S5ₖ₋₄ → S4ₖ | −10 | +10 |
| S0ₖ₋₄ → S3ₖ | −10 | +10 |
| S5ₖ₋₄ → S3ₖ | −10 | +10 |

Based on the reliability Pa-Pb of the decoding results in the above-mentioned 8 patterns, expression 7 is obtained.

Pattern-1

When (Cₖ₋₆, Cₖ, Cₖ₋₄, Cₖ₋₃, Cₖ₋₂, Cₖ₋₁, Cₖ)=(0,1,1,x,0,0,0), Pa-Pb=(Eₖ₋₃-Fₖ₋₃)+(Dₖ₋₂-Fₖ₋₂)+(Bₖ₋₁-Dₖ₋₁)+(Aₖ-Bₖ)

Pattern-2

When (Cₖ₋₆, Cₖ₋₅, Cₖ₋₄, Cₖ₋₃, Cₖ₋₂, Cₖ₋₁, Cₖ)=(1,1,1,x,0,0,0), Pa-Pb=(Fₖ₋₃-Gₖ₋₃)+(Dₖ₋₂-Fₖ₋₂)+(Bₖ₋₁-Dₖ₋₁)+(Aₖ-Bₖ)

Pattern-3

When (Cₖ₋₆, Cₖ₋₅, Cₖ₋₄, Cₖ₋₃, Cₖ₋₂, Cₖ₋₁, Cₖ)=(0,1,1,x,0,0,1), Pa-Pb=(Eₖ₋₃-Fₖ₋₃)+(Dₖ₋₂-Fₖ₋₂)+(Bₖ₋₁-Dₖ₋₁)+(Bₖ-Cₖ)

Pattern-4

When (Cₖ₋₆, Cₖ₋₅, Cₖ₋₄, Cₖ₋₃, Cₖ₋₂, Cₖ₋₁, Cₖ)=(1,1,1x,0,0,1), Pa-Pb=(Fₖ₋₃-Gₖ₋₃)+(Dₖ₋₂-Fₖ₋₂)+(Bₖ₋₁-Dₖ₋₁)+(Bₖ-Cₖ)

Pattern-5

When (Cₖ₋₆, Cₖ₋₅, Cₖ₋₄, Cₖ₋₃, Cₖ₋₂, Cₖ₋₁, Cₖ)=(0,0,0x,1,1,0), Pa-Pb=(Aₖ₋₃-Bₖ₋₃)+(Bₖ₋₂-Dₖ₋₂)+(Dₖ₋₁-Fₖ₋₃)+(Eₖ-Fₖ)

Pattern-6

When (Cₖ₋₆, Cₖ₋₅, Cₖ₋₄, Cₖ₋₃, Cₖ₋₂, Cₖ₋₁, Cₖ)=(1,0,0,x,1,1,0), Pa-Pb=(Bₖ₋₃-Cₖ₋₃)+(Bₖ₋₂-Dₖ₋₂)+(Dₖ₋₁-Fₖ₋₁)+(Eₖ-Fₖ)

Pattern-7

When (Cₖ₋₆, Cₖ₋₅, Cₖ₋₄, Cₖ₋₃, Cₖ₋₂, Cₖ₋₁, Cₖ)=(0,0,0,x,1,1,1), Pa-Pb=(Aₖ₋₃-Bₖ₋₃)+(Bₖ₋₂-Dₖ₋₂)+(Dₖ₋₁-Fₖ₋₁)+(Fₖ-Gₖ)

Pattern-8

When (Cₖ₋₆, Cₖ₋₅, Cₖ₋₄, Cₖ₋₃, Cₖ₋₂, Cₖ₋₁, Cₖ)=(1,0,0,x,1,1,1), Pa-Pb=(Bₖ₋₃-Cₖ₋₃)+(Bₖ₋₂-Dₖ₋₂)+(Dₖ₋₁-Fₖ₋₁)+(Fₖ-Gₖ)

Expression 7

Here, Aₖ=(yₖ-0)² , Bₖ=(yₖ-1)², Cₖ=(yₖ-2)², Dₖ=(yₖ-3)², E_{k=(y}ₖ₋₄)², Fₖ=(yₖ₋₅)², and Gₖ=(yₖ₋₆)². From the maximum likelihood decoding result Cₖ, Pa-Pb which fulfills expression 7 is obtained. From the distribution of Pa-Pb, the standard deviation σ₁₀ and the average value Pave₁₀ are obtained. Where the distribution of Pa-Pb is assumed to be a normal distribution, the error probability P₁₀ is represented by expression 8.

$${P}_{10} ( {σ}_{10} , {Pave}_{10} ) = erfc ( \frac{10 + {Pave}_{10}}{{σ}_{10}} ) \qquad expression 8$$

The above-mentioned 8 patterns generate a 1-bit shift error. The other patterns generate a 2- or more bit shift error. A result of analysis of post-PRML (partial response maximum likelihood) processing error patterns shows that most of the errors are 1-bit shift errors. Therefore, the error probability of the reproduction signal can be estimated by expression 8. In this manner, the standard deviation σ₁₀ and the average value Pave₁₀ can be used as the index of the quality of the reproduction signal. For example, the following definition can be provided using the above index as the PRML error index M:

M=σ₁₀/2·d²ₘᵢₙ expression 9.

In expression 9, d²ₘᵢₙ is the square of the minimum value of the Euclid distance, and is 10 by the combination of the modification symbol and the PRML system in this example. It is assumed that in expression 8, the average value Pave₁₀ is 0. The PRML error index M indicates the reliability of the maximum likelihood decoding result.

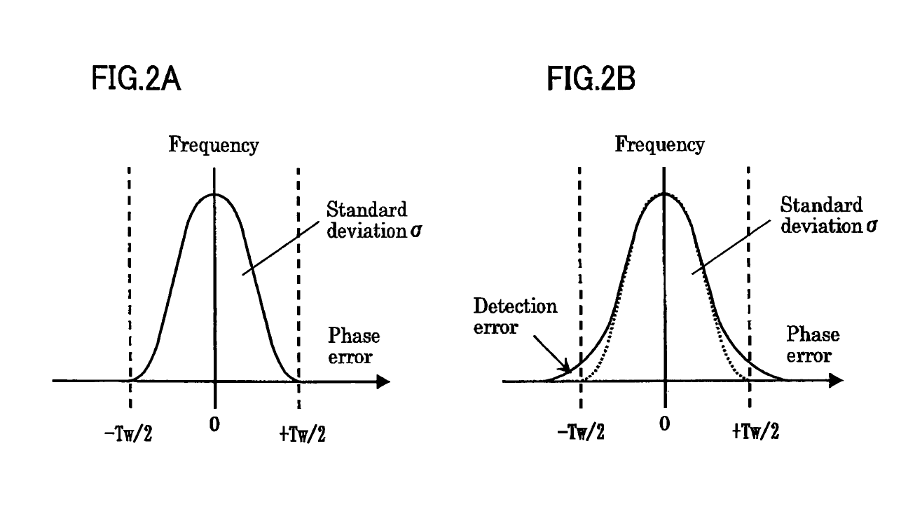

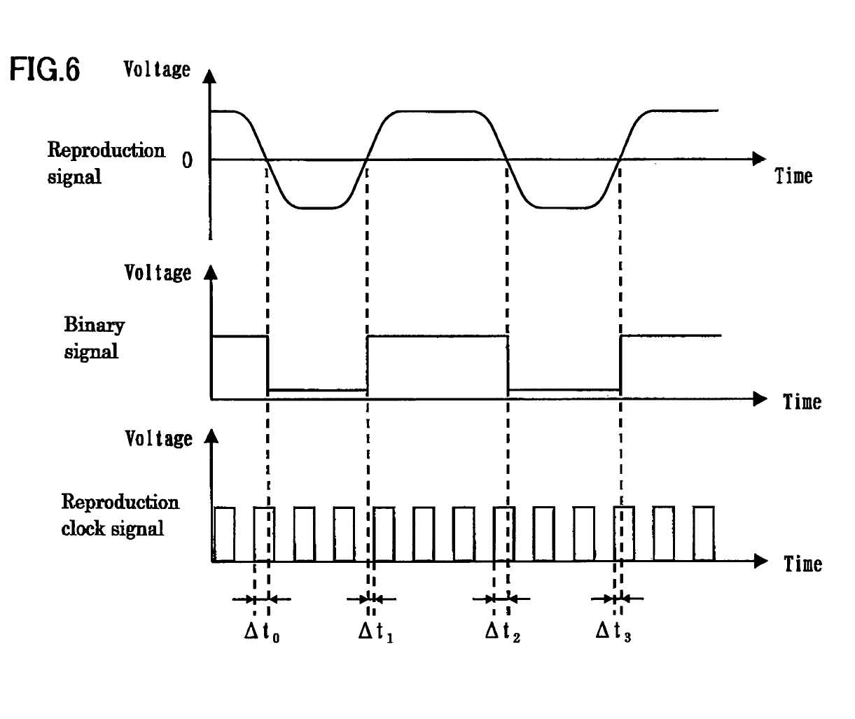

Next, a method for evaluating the reproduction signal quality regarding the jitter will be described. As an example, a reproduction signal waveform shown in FIG. 6 will be described. The reproduction signal wave form shown in FIG. 6 has only an AC component, and noise is superimposed thereon. The reproduction signal waveform is converted into a binary signal by a prescribed voltage level (in this example, level 0). The time-wise offsets between the rising and falling edge positions of the binary signal and the reproduction clock signal are phase errors. In FIG. 6, the phase error Δt between the edge position and the reproduction clock signal is Δt0, Δt1, Δt2, . . . due to the influence of noise. By accumulating the phase errors Δt, the distribution of the phase errors as shown in FIGS. 2A and 2B can be obtained. FIG. 2A shows a jitter distribution which is a normal distribution. FIG. 2B shows a jitter distribution which is partially deviated from a normal distribution. Here, the reproduction clock signal is a synchronous signal detected by the PLL circuit from the binary signal. When the reproduction parameter (or the recording parameter) is set such that the jitter is minimum, the reproduction clock signal can be extracted more accurately. The jitter is influenced by, for example, inter-symbol interference due to the recording marks and aberration of laser light as well as noise. Thus, the standard deviation σy can be calculated from the distribution of the phase errors Δt. Namely, the standard deviation σy can be used as an index of the reproduction signal quality. Jitter index J can be defined by expression 10 when regulated using the window width Tw. Jitter index J indicates the value of jitter.

J=σy/Tw expression 10

Next, a method for optimizing a parameter (reproduction parameter or recording parameter) will be described.

In this example, a first optimum value of the parameter is calculated based on the reliability. A second first optimum value of the parameter is calculated based on the jitter. A value of the parameter is set between the calculated first optimum value and the calculated second optimum value.

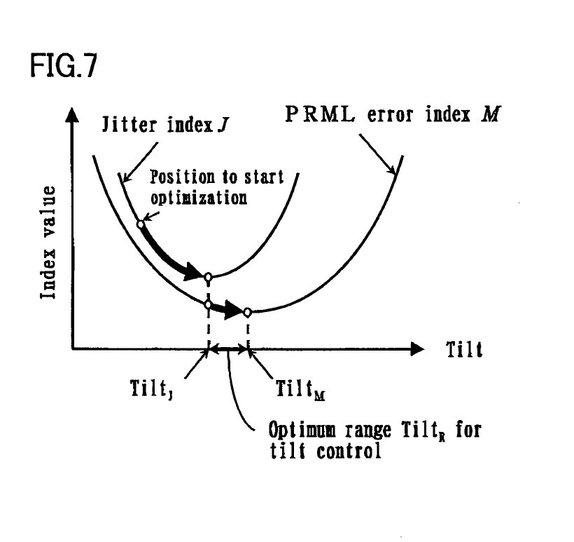

With reference to FIG. 7, a method for optimizing a parameter (reproduction parameter or recording parameter) for tilt control will be described. This method uses the PRML error index M and the jitter index J. Tilt control controls the tilt of the optical head with respect to the optical disc. First, the tilt control section optimizes the tilt of the optical head, i.e., the incident angle of the laser light on the optical disc, in order to minimize the jitter index J. For example, the tilt of the optical head is changed by a small amount by tilt control, and the jitter indices J before and after the change are compared. The tilt angle corresponding to a smaller jitter index J is selected. By repeating this operation, the jitter index J can be converged to a minimum value (namely, the value of jitter becomes minimum). Next, in a similar manner, the tilt control section optimizes the tilt of the optical head in order to minimize the PRML error index M (namely, the reliability becomes highest). Where the optimum tilt of the optical head regarding the jitter index J is Tilt_{J} and the optimum tilt of the optical head regarding the PRML error index M is Tiltₘ, the optimum parameter of tilt control is a value between Tilt_{J} and Tilt_{M} inclusive (optimum range: Tilt_{R}). For example, an average value of the Tilt_{J} and Tilt_{M} is set as the optimum value.

The above-mentioned average value is suitable for reproducing data recorded by another recording or reproduction apparatus, but may not be suitable for recording data by the recording or reproduction apparatus on which the information recording medium is currently mounted. (For example, in the case where the tilt angle is the average value when recording data by the recording or reproduction apparatus on which the information recording medium is currently mounted, the laser light may be incident obliquely on an information recording surface of the information recording medium. In such a case, the recording mark becomes asymmetric, and the error generation probability is increased.) In order to alleviate the degree of asymmetry and thus reduce the error generation probability, the optimum angle may be changed within the range between Tilt_{J} and Tilt_{M} inclusive in accordance with the circumstance; it is not absolutely necessary to set the optimum angle at the average value. For example, the optimum angle may be set as follows: The angle may be made closer to Tilt_{J} or Tilt_{M} than the average value, and the position at which the distance from Tilt_{J}: the distance from Tilt_{M} is a:b (a and b are each an integer) is set as the optimum angle. Alternatively, the tilt angle may be different for reproduction and for recording; for example, the optimum angle may be set as the angle corresponding to the average value for reproduction, and tilt control may be performed such that the optimum angle is the position corresponding to the ratio of a:b for recording. In a method for minimizing the other types of control, the optimum value is not limited to the average value of the optimum parameters of the two indices.

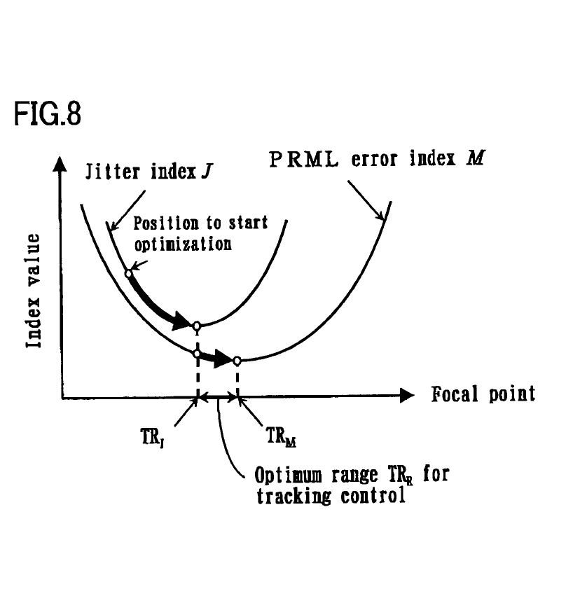

With reference to FIG. 8, a method for optimizing a parameter (reproduction parameter or recording parameter) for tracking control will be described. This method uses the PRML error index M and the jitter index J. Tracking control controls the focal point of the laser light emitted from the optical head to be on a track of the optical disc. First, the tracking control section optimizes the focal point of the laser light in a transverse direction of the track such that the jitter index J is minimum. For example, the focal point is changed by a small distance by tracking control, and the jitter indices J before and after the change are compared. The focal point corresponding to a smaller jitter index J is selected. By repeating this operation, the jitter index J can be converged to a minimum value. Next, in a similar manner, the tracking control section optimizes the focal point of the laser light in a transverse direction of the track in order to minimize the PRML error index M. Where the optimum focal point of the laser light regarding the jitter index J is TR_{J} and the optimum focal point of the laser light regarding the PRML error index M to TR_{M}, the optimum parameter of tracking control is a value between TR_{J} and TR_{M} inclusive (optimum range: TR_{R}). For example, the focal point corresponding to an average value of the TR_{J} and TR_{M} is the optimum focal point.

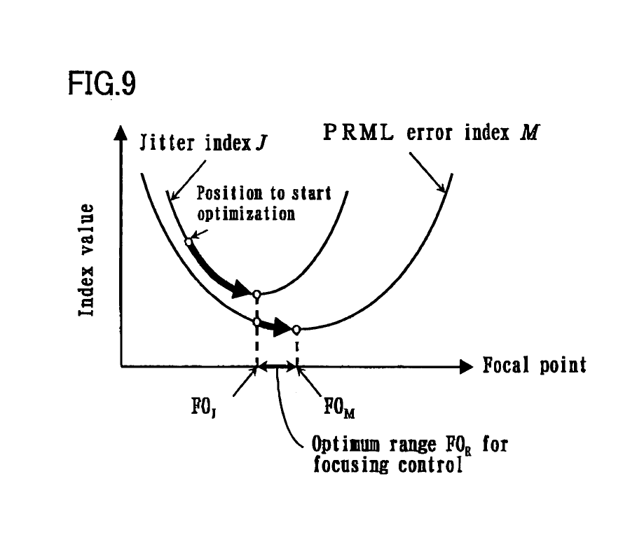

With reference to FIG. 9 a method for optimizing a parameter (reproduction parameter or recording parameter) for focusing control will be described. This method uses the PRML error index M and the jitter index J. Focusing control controls the focal point of the laser light emitted from the optical head to be on an information recording surface of the optical disc. First, the focusing control section optimizes the focal point of the laser light in an optical path direction, such that the jitter index J is minimum. For example, the focal point is changed by a small distance by focusing control, and the jitter indices J before and after the change are compared. The focal point corresponding to a smaller jitter index J is selected. By repeating this operation, the jitter index J can be converged to a minimum value. Next, in a similar manner, the focusing control section optimizes the focal point of the laser light in the optical path direction in order to minimize the PRML error index M. Where the optimum focal point of the laser light regarding the jitter index J is FO_{J} and the optimum focal point of the laser light regarding the PRML error index M is FO_{M}, the optimum parameter of focusing control is a value between FO_{J} and FO_{M} inclusive (optimum range: FO_{R}). For example, the focal point corresponding to an average value of the FO_{J} and FO_{M} is the optimum focal point.

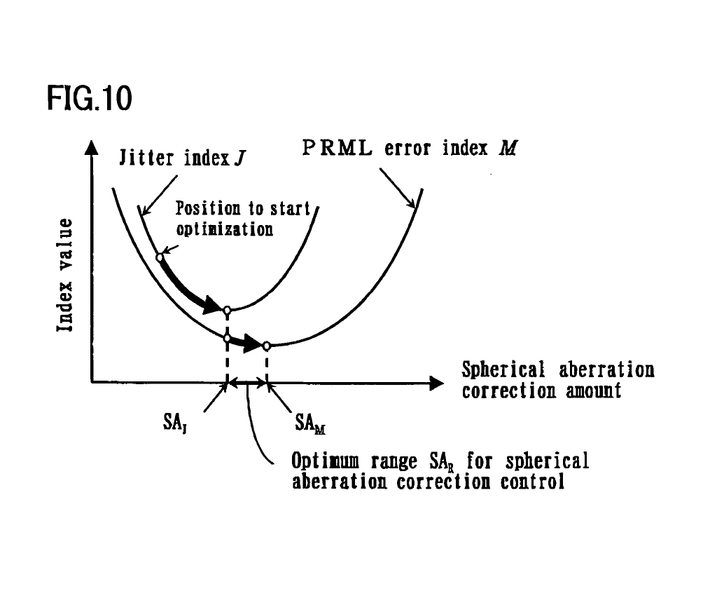

With reference to FIG. 10, a method for optimizing a parameter (reproduction parameter or recording parameter) for spherical aberration correction control will be described. This method uses the PRML error index M and the jitter index J. Spherical aberration correction control performs spherical aberration correction such that the spherical aberration of the laser light is minimum. The spherical aberration of the laser light is generated on the information recording surface of the optical disc due to errors in the thickness of the objective lens, the inter-lens distance, or the like. More specifically, the spherical aberration correction control changes the position of a lens in order to control the expansion of the laser light incident on the objective lens and thus to reduce the aberration on the information recording surface. First, the spherical aberration correction control section optimizes the spherical correction control amount such that the jitter index J is minimum. For example, the spherical correction control amount is changed by a small amount by the spherical aberration correction control, and the jitter indices J before and after the change are compared. The spherical correction control amount corresponding to a smaller jitter index J is selected. By repeating this operation, the jitter index J can be converged to a minimum value. Next, in a similar manner, the spherical aberration correction control section optimizes the spherical aberration correction amount in order to minimize the PRML error index M. Where the optimum spherical aberration correction amount regarding the jitter index J is SA_{J} and the optimum spherical aberration correction amount regarding the PRML error index M is SA_{M}, the optimum parameter of spherical aberration correction control is a value between SA_{J} and SA_{M} inclusive (optimum range: SA_{R}). For example, the spherical aberration correction amount corresponding to an average value of the SA_{J} and SA_{M} is the optimum spherical aberration correction amount.

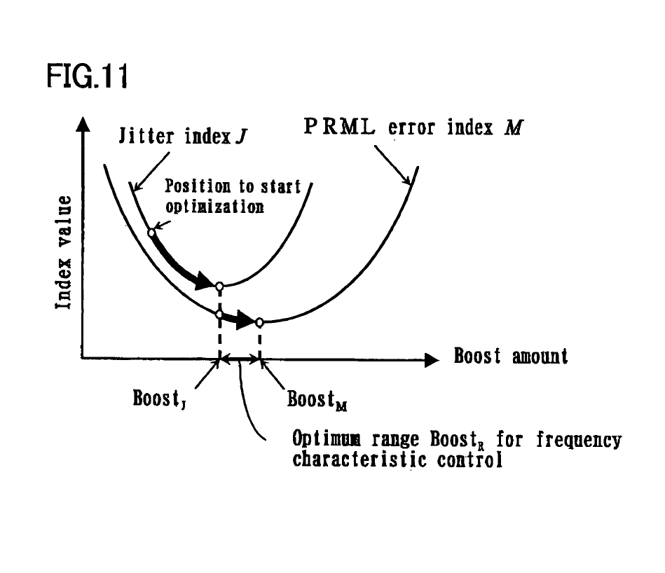

With reference to FIG. 11, a method for optimizing a parameter (reproduction parameter or recording parameter) for frequency characteristic control of a waveform equalizer will be described. This method uses the PRML error index M and the jitter index J. Frequency characteristic control controls the frequency characteristic of the waveform equalizer (for example, boost amount or boost central frequency). First, the frequency characteristic control section optimizes the boost amount such that the jitter index J is minimum. For example, the boost amount is changed by a small amount by the frequency characteristic control, and the jitter indices J before and after the change are compared. The boost amount corresponding to a smaller jitter index J is selected. By repeating this operation, the jitter index J can be converged to a minimum value. Next, in a similar manner, the frequency characteristic control section optimizes the boost amount in order to minimize the PRML error index M. Where the optimum boost amount regarding the jitter index J is Boost_{J} and the boost amount regarding the PRML error index M is Boost_{M}, the optimum parameter of frequency characteristic control is a value between Boost_{J} and Boost_{M} inclusive (optimum range: Boost_{R}). For example, the boost amount corresponding to an average value of the Boost_{J} and Boost_{M} is the optimum boost amount. The frequency characteristic control is applicable to the boost central frequency.

In this example, methods for optimizing target values in tilt control, tracking control, focusing control, and spherical aberration correction control as examples of servo control are described. The present invention is also applicable to optimize other types of servo control, for example, lens shift control. The reproduction parameter and the recording parameter are determined by the above-described optimization methods.

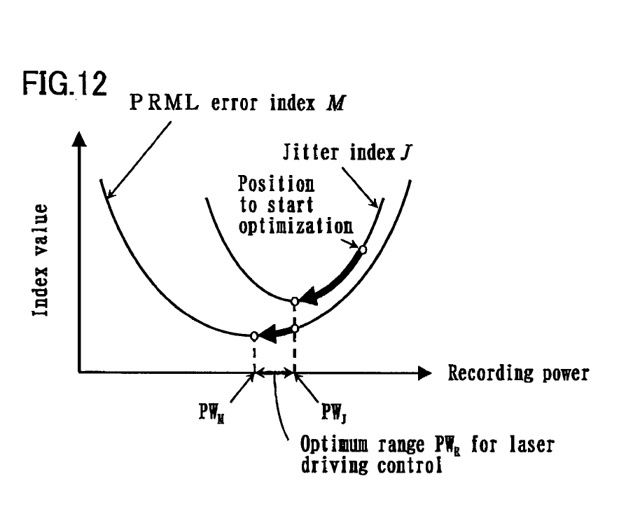

With reference to FIG. 12, a method for optimizing a recording parameter for laser driving control will be described. This method uses the PRML error index M and the jitter index J. The laser driving control sets the laser power used for recording information on the optical disc. Laser driving control controls the power of the laser light emitted by the optical head. Information is recorded while changing the recording power by a small degree by laser driving control, and the recorded signal is reproduced. Thus, the recording power PW_{J} at which the jitter index J is minimum is determined. In a similar manner, the recording power PW_{M} at which the PRML error index M is minimum is determined. As a result, a power value in the range between PW_{J} and PW_{M} inclusive (optimum range: PW_{R}) is determined as the optimum power value. For example, an average of PW_{J} and PW_{M} is determined as the optimum power value.

In this example, the optimum parameter regarding the jitter index J is detected and then the optimum parameter regarding the PRML error index M is detected. Alternatively, the optimum parameter regarding the PRML error index M may be detected and then the optimum parameter regarding the jitter index J may be detected.

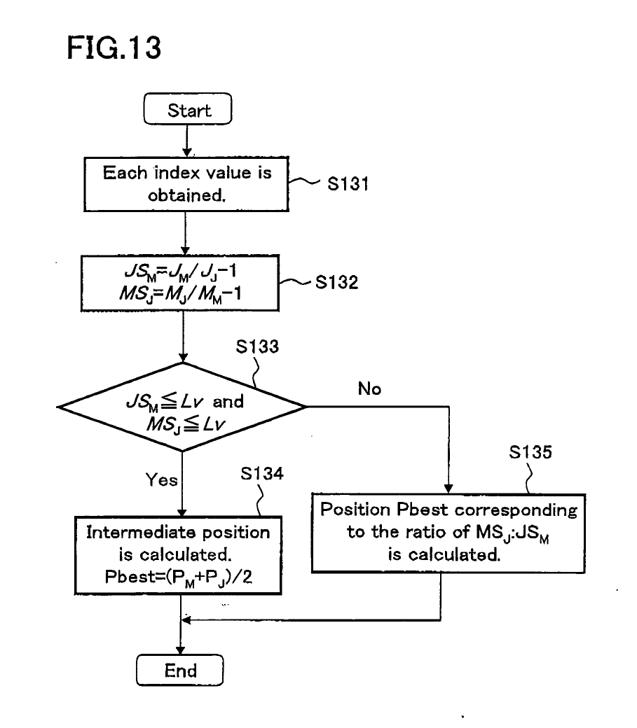

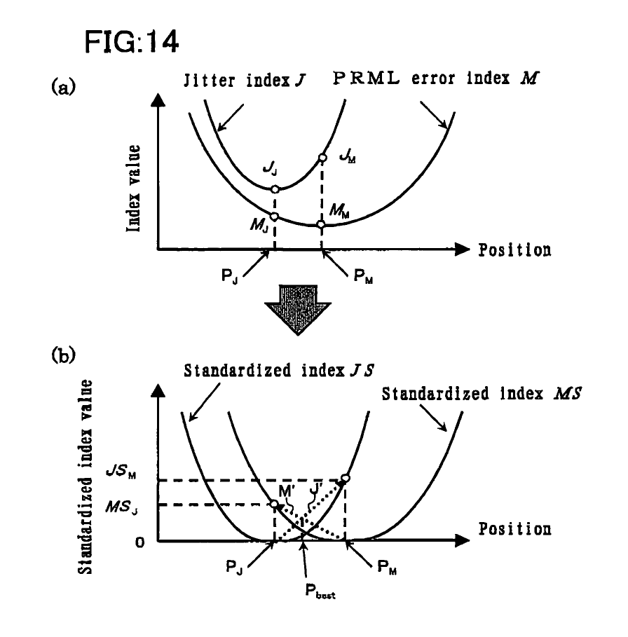

Another method for calculating the optimum position using the optimization method according to the present Invention will be described with reference to FIGS. 13 and 14.

FIG. 13 is a flowchart illustrating a method for calculating an optimum position. FIG. 14 illustrates standardization of each index value. Here, it is assumed that the optimum position regarding each index value is already detected. As shown in FIG. 14, where the optimum position regarding jitter index J is P_{J} and the optimum position regarding PRML error index M is P_{M}, the jitter error Index at position P_{J} is J_{J} (optimum value), the PRML error index at position P_{J} is M_{J}, jitter error index at position Pₘ is J_{M}, and the PRML error index at position P_{M} is M_{M} (optimum value).

First, each index value detected during the optimum position detection process is obtained (S131). Next, MS_{J} obtained by standardizing the index value M_{J} at position P_{J} with the optimum value M_{M}, and JS_{M} obtained by standardizing the index value J_{M} at position P_{M} with the optimum value J_{J}, are calculated by MS_{J}=(M_{J}/M_{M}-1) and JS_{M}=(J_{M}/J_{J}-1) (S132). Thus, the deterioration tendency of the different index values caused by the change in position can be compared under the same criteria. In this example, the deterioration tendency of each index value when the position corresponding to the index value is changed from the optimum position to the optimum position of another index value is determined based on standardized values JS_{M} and MS_{J} (S133), and thus the optimum position P_{best} is determined. When the standardized values JS_{M} and MS_{J} are both equal to or less than reference level Lv (e.g., 0.03), namely, when no substantial deterioration tendency caused by detection errors is found for either index value, the optimum position P_{best} can be set at any position between positions P_{J} and P_{M} inclusive. For example, the optimum position P_{best} can be set at an intermediate position between the positions P_{J} and P_{M} inclusive (S134). Even when the standardized values JS_{M} and MS_{J} exceed reference level Lv, optimum position P_{best} can be determined as P_{best}=(MS_{J}*P_{M}+JS_{M}*P_{J})/(MS_{J}+JS_{M}) in accordance with the ratio of the standardized values JS_{M} and MS_{J} (S135). The reason is that the optimum position P_{best} is determined in accordance with the deterioration tendency of each standardized value. In S135, (distance between P_{J} and P_{best}):(distance between P_{M} and P_{best})=MS_{J}:JS_{M}.

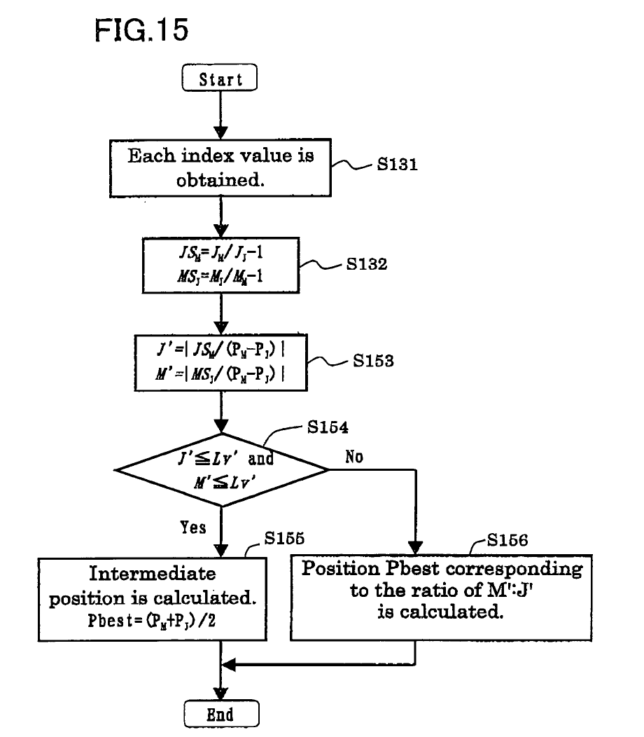

In the above-described method, the optimum position P_{best} is determined in accordance with the ratio of the standardized values JS_{M} and MS_{J}. Alternatively, as shown in FIG. 15, the optimum position may be determined by determining the deterioration tendency (gradient) of the standardized values JS_{M} and MS_{J} in accordance with the position change between positions P_{J} and P_{M}. In this, case, the gradients J′ and M′ of each index are calculated by J′=|JS_{M}/(P_{M}-P_{J})| and M′=|MS_{J}/(P_{M}-P_{J}) (S153). This indicates that as the gradient is larger, the deterioration degree of the index value is larger. The reference level Lv′ regarding the gradient is obtained by |Lv/(P_{M}-P_{J})|. Depending on whether the gradients J′ and M′ of each index value are equal to or less than the reference level Lv′ or not (S154), the positions can be determined (S155 and S156). The operation in S155 and S156 is basically the same as the operation in S134 and S135. In S156, (distance between P_{J} and P_{best}):(distance between P_{M} and P_{best})=M′:J′. In this case, the value of the prescribed parameter is set such that the value of the prescribed parameter is closer to an optimum value calculated based on either the reliability or the jitter, which is changed at a larger change ratio when the value of the prescribed parameter is changed, than to an optimum value calculated based on either the reliability or the jitter, which is changed at a smaller change ratio when the value of the prescribed parameter is changed.

In the above example, the reference level Lv is applied to both the standardized values JS_{M} and MS_{J}. Alternatively, a different reference level may be applied to each standardized value. When one of the indices is equal to or less than the reference level Lv, an index value which is larger than the reference level Lv may be used.

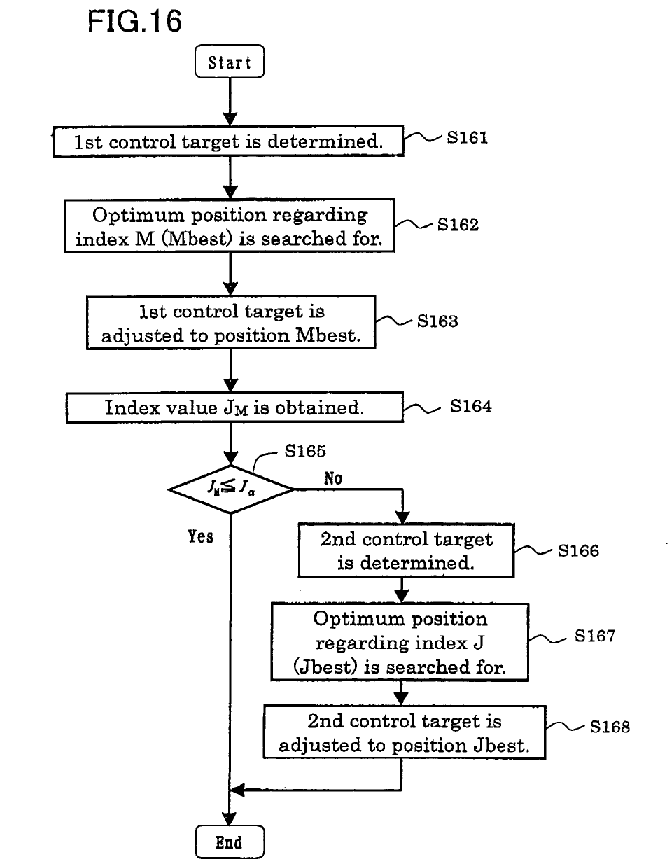

Next, still another method for calculating the optimum position using the optimization method according to the present invention will be described with reference to FIG. 16.

First, a recording parameter or a reproduction parameter to be controlled is determined (S161). A first control target in S161 is, for example, a focal point. Next, the focal point of laser light at which the RPML error index M is minimum is searched for by focusing control (S162) and the focal point is adjusted to the optimum position M_{best} (S163). Then, the jitter index value J_{M} corresponding to the optimum position M_{best} is obtained (S164). When the jitter index value J_{M} is equal to or less than a prescribed value J_{α} (e.g., 15%) in S165, the optimum position M_{best} is determined as having no influence on the jitter index J. Thus, the control of the recording or reproduction parameter is terminated (namely, the focal point is set to be the optimum position M_{best}). When the jitter index value J_{M} is greater than the prescribed value J_{α} (e.g., 15%) in S165, it is determined that the reproduction clock signal has reached a point outside the assumed range and appropriate signal processing is impossible. Thus, another recording or reproduction parameter is controlled (S166). For example, a frequency characteristic of the waveform equalizer is determined to be a second control target. Next, a frequency characteristic (for example, boost amount) at which the jitter index J is minimum is searched for by frequency characteristic control (S167), and the frequency characteristic is adjusted to the optimum position J_{best} (S168).

In this manner, one control target is controlled regarding the PRML error index M and another control target is controlled regarding the jitter index J. Thus, the recording or reproduction parameter can be adjusted so as to have a value suitable to both of the indices.

In this example, the first control target is the focal point, and the second control target is the frequency characteristic of the waveform equalizer. The calculation method is applicable to other recording or reproduction parameters. In this example, the first control target is optimized regarding the PRML error index M and the second control target is optimized regarding the jitter index J. Alternatively, the first control target is optimized regarding the jitter index J and the second control target is optimized regarding the PRML error index M. In order to improve the precision of adjustment of the first control target, the first control target may be adjusted the second time after the second control target is adjusted.

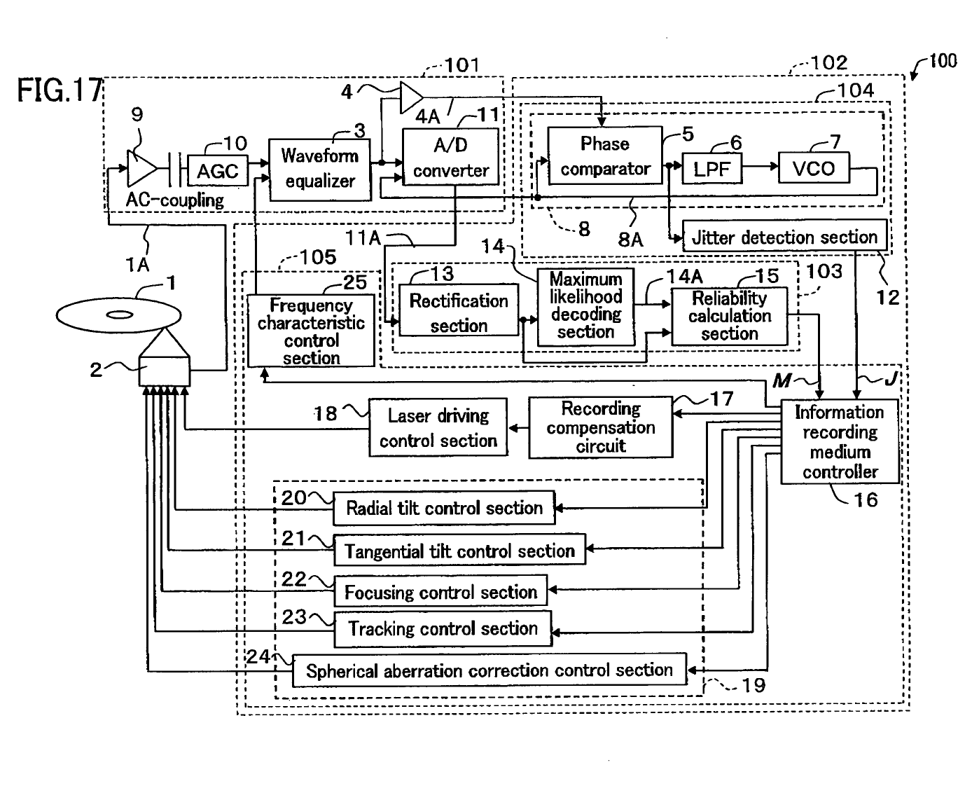

FIG. 17 shows an apparatus 100 for executing the above-described method for optimizing a recording or reproduction parameter in one example of the present Invention. The apparatus 100 records information on, or reproduces information from, an information recording medium 1. The apparatus 100 may perform both recording and reproduction. The information recording medium 1 is a medium for optical information recording and/or reproduction, and is, for example, an optical disc.

The apparatus 100 includes a reproduction section 101, a control device 102 for controlling information recording on, or information reproduction from, the information recording medium 1, and an optical head section 2. The control device 102 may control both recording and reproduction.

The reproduction section 101 processes an analog signal 1A representing information reproduced from the information recording medium 1 by the optical head section 2. Specifically, the reproduction section 101 performs amplitude adjustment, waveform equalization or the like of the analog signal 1A. The reproduction section 101 generates a digital signal 11A based on the post-processing analog signal 1A and a reproduction clock signal 8A. A comparator 4 included in the reproduction section 101 generates a binary signal 4A based on the post-processing analog signal 1A and a threshold value. The threshold value used by the comparator 4 is set based on, for example, a central value of the amplitude of the analog signal 1A or a central value of the amplitude of a shortest mark signal included in the analog signal 1A.

The control device 102 includes a first calculation section 103, a second calculation section 104, and a parameter setting section 105. The control device 102 is produced as, for example, a semiconductor chip. The parameter setting section 105 sets a value of a prescribed parameter, which is one of a recording parameter and a reproduction parameter. The first calculation section 103 receives the digital signal 11A, and calculates, based on the digital signal 11A, a first index used for setting a value of the prescribed parameter. The second calculation section 104 receives a binary signal 4A and calculates, based on the binary signal 4A, a second index used for setting a value of the prescribed parameter. The parameter setting section 105 calculates a first optimum value of the prescribed parameter based on the first index, and calculates a second optimum value of the prescribed parameter based on the second index. The parameter setting section 105 sets a value of the prescribed parameter between the first optimum value and the second optimum value inclusive. The parameter setting section 105 may calculate the first optimum value based on an accumulated value or an average value of first index values. The parameter setting section 105 may calculate the second optimum value based on an accumulated value or an average value of second index values. The optical head section 2 performs at least one of information reproduction and information recording based on the prescribed parameter. In this example, the first index is the PRML error index M, which indicates the reliability of the maximum likelihood decoding result. The second index is the jitter index J, which indicates jitter. The first index and the second index are not limited to these.

The first calculation section 103 includes a rectification section 13, a maximum likelihood decoding section 14, and a reliability calculation section 15. The rectification section 13 is, for example, a digital filter. The rectification section 13 receives the digital signal 11A and rectifies the waveform of the digital signal 11A, such that the digital signal 11A has a prescribed PR equalization characteristic. The maximum likelihood section 14 is, for example, a Viterbi decoding circuit. The maximum likelihood section 14 performs maximum likelihood decoding of the digital signal 11A having the waveform thereof rectified, and generates a binary signal 14A representing the maximum likelihood decoding result. The reliability calculation section 15 is, for example, a differential metric analyzer. The reliability calculation section 15 calculates the reliability of the maximum likelihood decoding result based on the digital signal 11A having the waveform thereof rectified and the binary signal 14A.

The second calculation section 104 includes a clock signal generation section 8 and a jitter detection section 12. The clock signal generation section 8 is, for example, a PLL circuit. The clock signal generation section 8 detects a phase error between the binary signal 4A and the reproduction clock signal 8A, and adjusts the phase of the reproduction clock signal 8A based on the detected phase error, such that the phase error is reduced. The jitter detection section 12 detects jitter based on the phase error detected by the clock signal generation section 8.

The reproduction section 101 includes a preamplifier 9, an AGC 10, a waveform equalizer 3, an A/D converter 11, and the comparator 4. The optical head section 2 generates the analog signal 1A representing information read from the information recording medium 1. The analog signal 1A is amplified by the preamplifier 9. After being AC-coupled, the analog signal 1A is input to the AGC 10. The AGC 10 adjusts a gain of the analog signal 1A such that the output from the waveform equalizer 3 in the subsequent stage has a constant amplitude. The analog signal 1A output from the AGC 10 is waveform-rectified by the waveform equalizer 3. The waveform-rectified analog signal 1A is input to the A/D converter 11 and the comparator 4. The A/D converter 11 samples the analog signal 1A in synchronization with the reproduction clock signal 8A which is output from the clock signal generation section 8. The comparator 4 compares the reference voltage (threshold value) and the analog signal 1A, and generates the binary signal 4A based on the comparison result.

The clock signal generation section 8 includes a phase comparator 5, an LPF (low pass filter) 6, and a VCO (voltage controlled oscillator) 7. The phase comparator 5 detects a phase error between the binary signal 4A and the reproduction clock signal 8A. The phase error is output to the LPF 6 and the jitter detection section 12. The LPF 6determines a frequency component to be followed by the VCO 7 based on the phase error. The VCO 7 generates the reproduction clock signal 8A which is necessary for sampling performed by the A/D converter 11.

The digital signal 11A is output from the A/D converter 11 to the rectification section 13. The jitter detection section 12 accumulates phase errors output from the clock signal generation section 8 for a prescribed time period or by a prescribed number of times, calculates a jitter index J based on the resultant distribution of phase errors, and sends the jitter index J to an information recording medium controller 16.

The rectification section 13 adjusts the frequency characteristic of the digital signal during recording or reproduction to be the characteristic assumed by the maximum likelihood decoding section 14 (in this example, a characteristic equivalent to PR (1,2,2,1)). Namely, the rectification section 13 rectifies the waveform of the digital signal 11A. The maximum likelihood decoding section 14 performs maximum likelihood decoding of the waveform-rectified digital signal 11A which is output from the rectification section 13, and outputs the binary signal 14A having the maximum likelihood. The digital signal 11A output from the rectification section 13 and the binary signal 14A output from the maximum likelihood decoding section 14 are input to the reliability calculation section 15. The reliability calculation section 16 identifies a state transition from the binary signal 14A, and calculates a PRML error index M representing the reliability of the maximum likelihood decoding result from the identification result and the branch metric (see expression 9). The PRML error index M is sent to the information recording medium controller 16. The reliability calculation section 15 calculates the reliability based on a digital signal corresponding to each of a start and an end of a recording mark formed on the information recording medium 1 and the binary signal 14A.

The parameter setting section 105 includes the information recording medium controller 16, an information compensation circuit 17, a laser driving section 18, a servo control section 19, and a frequency characteristic control section 25. The servo control section 19 includes a tilt control section (including a radial tilt control section 20 and a tangential tilt control section 21), a focusing control section 22, a tracking control section 23, and a spherical aberration correction control section 24. These control sections are used for the optimization described above.

The information recording medium controller 16 determines, based on the PRML error index M and the jitter index J, whether or not the reproduction parameter such as the target value in servo control, the frequency characteristic of the waveform equalizer 3, or the like, or the recording parameter such as the recording laser power or the like is appropriate. When the recording or reproduction parameter is determined to be inappropriate at the start of recording on or reproduction from the information recording medium 1, the information recording medium controller 16 estimates a more appropriate parameter. The information recording medium controller 16 newly sets a recording or reproduction parameter in each control section for controlling recording or reproduction. Then, the information recording medium controller 16 obtains a recording or reproduction parameter value X1, which is optimum for the PRML error index M, and a recording or reproduction parameter value X2, which is optimum for the jitter J. The parameter value of each control section is set to be between the parameter value X1 and the parameter value X2 inclusive. The control sections are, for example, the laser driving section 18, the frequency characteristic control section 25, and the control sections 20 through 24 included in the servo control circuit 19.

The radial tilt control section 20 tilts the optical head section 2 in a radial direction of the information recording medium 1. The tangential tilt control section 21 tilts the optical head section 2 in a track scanning direction of the information recording medium 1. The focusing control section 22 performs focusing control such that the laser light emitted from the optical head section 2 is in an optimum convergence state on the information recording surface of the information recording medium 1. The tracking control section 23 performs tracking control such that the focal point of the laser light can correctly follow the track of the information recording medium 1. The spherical aberration correction control section 24 performs spherical aberration correction control such that the spherical aberration of the laser light on the information recording surface of the information recording medium 1 is minimum. The frequency characteristic control section 25 performs frequency characteristic control such that the frequency characteristic of the waveform equalizer 3 (a boost amount, a boost central frequency, etc.) is optimum. The laser driving section 18 controls the power of the laser light emitted by the optical head section 2.

As one exemplary operation of the information recording medium controller 16 for controlling each control section to have an optimum recording or reproduction parameter, a control operation of the laser driving section 18 and recording power learning performed to determine the recording power at which the information is recorded on the information recording medium 1 will be described. In the recording power learning, information is recorded on a track while changing the recording laser power at a prescribed interval, and recorded information is reproduced. The quality of the reproduced signal is evaluated, and thus the optimum recording power for the information recording medium 1 is determined.

According to the present invention, the laser driving section 18 controls the output level of the recording power, and the information recording medium controller 16 controls the laser driving section 18. The information recording medium controller 16 determines an initial value of the recording power from the information recorded on the information recording medium 1. The laser driving section 18 outputs laser light having the recording power corresponding to the initial value and thus records information on a track of the information recording medium 1. The recorded information is reproduced, and thus a PRML error index M₀ and a jitter index J₀ are detected. The set recording power and detected indices are stored in the information recording medium controller 16.

Next, the information recording medium controller 16 instructs the laser driving section 18 to record information with a recording power which is different by a certain degree (for example, different by 5% from the initial value). A PRML error index M₁ and a jitter index J₁ are detected from the recorded information. The PRML error index M₁ and a jitter index J₁ are compared with the PRML error index M₀ and the jitter index J₀. Better indices and the corresponding recording power are stored in the information recording medium controller 16.

By repeating the above-described operation, an optimum power PW_{M} at which the PRML error index M is minimum, and an optimum recording power PW_{J} at which the jitter index J is minimum are obtained. The information recording medium controller 16 calculates an average power PW_{C} of the optimum power PW_{M} and the optimum recording power PW_{J}, and determines the average power PW_{C} as the optimum power. The information recording medium controller 16 instructs the laser driving section 18 to perform recording with laser light having a power of PW_{C}. The optimum power is not limited to the average power of the optimum power PW_{M} and the optimum recording power PW_{J}. Alternatively, a power value at which the difference from PW_{M}:the difference from PW_{J}=a:b (a and b are each an integer) may be set as the optimum power.

In this example, a method for controlling the power of the laser light of the laser driving section 18 is described. A similar manner of control is performed for the other control sections. The other control sections are, for example, the radial tilt control section 20, the tangential tilt control section 21, the focusing control section 22, the tracking control section 23, the spherical aberration correction control section 24, and the frequency characteristic control section 25.

In the above example, the maximum likelihood decoding section 14 performs maximum likelihood decoding using a state transition rule defined by the recording symbol having a minimum polarity inversion interval of 2and the equalization system of PR (1,2,2,1). The present invention is not limited to this. For example, the present invention is applicable to the case where the recording symbol is a (1,7) modification symbol and the minimum polarity inversion interval is 2. When using a recording symbol, such as an 8-16 modification symbol used in DVDs, having a minimum polarity inversion interval of 3, the present invention is performed using the following: for example, an equalization system PR (1, 2, 2, 1) and a state transition rule in which there are six states at time k and the number of state transitions from the six states at time k to six states at time k+1 is limited to eight. The present invention is applicable to use of, for example, a state transition rule defined by the recording symbol having a minimum polarity inversion interval of 3 and the equalization system of PR (C0,C1,C1,C0), a state transition rule defined by the recording symbol having a minimum polarity inversion interval of 2 or 3 and the equalization system of PR (C0,C1,C0), and a state transition rule defined by the recording symbol having a minimum polarity inversion interval of 2 or 3 and the equalization system of PR (C0,C1,C2,C1,C0). C0, C1 and C2 are each an arbitrary positive numeral.

Each of the optimization methods described above do not need to be applied to all the control sections, but may be applied to at least one of the control sections. In the above example, the information recording medium controller 16 determines the optimum value of each of the jitter index J and the PRML error index M is determined and controls the controls sections. Alternatively, another section may be provided between the information recording medium controller 16 and the jitter detection section 12 and between the information recording medium controller 16 and the reliability calculation section 15 for determining the optimum value of each index.

A digital PLL circuit (not shown) may be provided in the clock signal generation section 8 for processing the digital signal 11A. In this case, jitter may be detected by outputting phase information generated by the digital PLL circuit to the jitter detection section 12. The digital PLL circuit processes the digital signal 11A output from the A/D converter 11, and therefore, the comparator 4 is not necessary.

The methods and the apparatus described above detect a recording or reproduction parameter such as, for example, the tilt of the optical head, the focal point of laser light, the spherical aberration correction amount, the frequency characteristic, and the recording power at which the jitter index J and the PRML error index M are optimum. The methods and the apparatus described above then perform recording on or reproduction from an information recording medium, with each index being set in a scope determined by the detected optimum values regarding the jitter index J and the PRML error index M. It is preferable that the information recording medium has each index. For example, the information recording medium preferably fulfills a prescribed value Jstd regarding the jitter index J and a prescribed value Mstd regarding the PRML error index M. The recording or reproduction parameter may be different depending on, for example, the layer structure and material of the recording information medium; characteristics of the recording or reproduction apparatus including the wavelength or output power of the laser light; and the recording conditions including the recording density, the linear velocity and the modification system. When evaluating the recording characteristics or reproduction characteristics of the information recording medium, for example. (i) the recording or reproduction parameter X1 determined when the PRML error index M is detected, and (ii) the recording or reproduction parameter X2 determined when the jitter index J is detected, are determined for the same type of parameters. In the case where the information recording medium fulfills each index, information can be recorded on, or reproduced from, the information recording medium even by a recording or reproduction apparatus which detects the optimum value of only one index. Thus, the degree of freedom of developing the recording or reproduction apparatuses can be improved.

In order to realize a method and apparatus according to the present inventions it is preferable that the information recording medium does not have any problem in terms of recording characteristics or reproduction characteristics. A method and apparatus for evaluating the characteristics of the information recording medium usable for the present invention will be described.

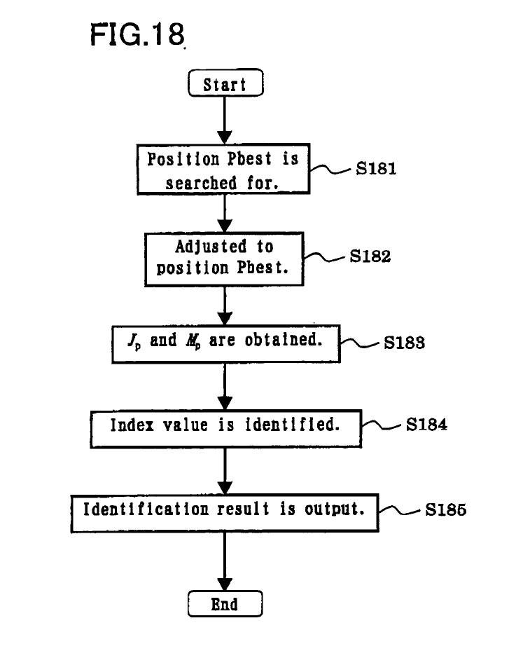

A method for evaluation will be described with reference to FIG. 18. First, the optimum position P_{best} is calculated by one of the above-described optimization methods (S181), and the recording or reproduction conditions are controlled to correspond to the optimum position P_{best} (S182). Next, the jitter index Jp and the PRML error index Mp at the optimum position P_{best} are obtained (S183). The jitter index Jp is compared with a prescribed value Jstd (e.g., 7%), and the PRML error index Mp is compared with a prescribed value Mstd (e.g., 10%), thereby determining the characteristics of the information recording medium (S184). For determining the characteristics of the information recording medium, the conditions of Jp≦Jstd and Mp≦Mstd are used. Then, the determination results representing information on the differences from the prescribed values or the like are output (S185). Thus, it can be evaluated whether or not the recording or reproduction characteristics of the information recording medium created for tests or the like fulfill the desirable conditions.

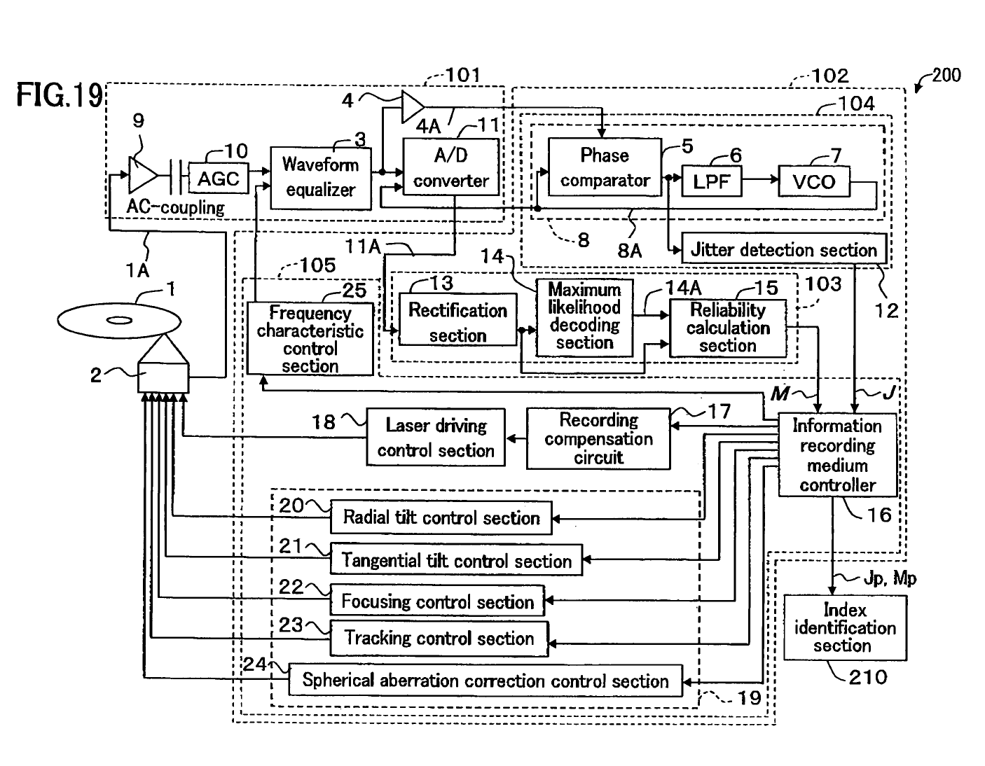

FIG. 19 shows an information recording medium identification apparatus 200 for performing the above-described evaluation method. The information recording medium identification apparatus 200 includes an index determination section 210 in addition to the elements included in the apparatus 100 shown in FIG. 17. Identical elements previously discussed with respect to FIG. 17 bear identical reference numerals and the detailed descriptions thereof will be omitted.

With reference to FIG. 19, the information recording medium controller 16 optimizes a recording or reproduction parameter of each control section based on the jitter index J input from the jitter detection section 12 and the PRML error index M input from the reliability calculation section 15. Then, the index values Jp and Mp are again detected under the set parameter, and the detected index values Jp and Mp are output to the index determination section 210. The index determination section 210 compares the index values Jp and Mp with prescribed values Jstd and Mstd set for the respective indices. The comparison results (S184) are output to an external device such as a host computer or the like. Thus, it can be determined whether or not the recording or reproduction characteristics of the information recording medium created for tests or the like fulfill the desirable conditions.

When calculating the optimum position P_{best}, best values J_{J} and M_{M} for the respective indices are detected. Therefore, a prescribed Jstd0 (≦Jstd) and an Mstd0 (≦Mstd) are applicable to the best values J_{J} and M_{M}. For determining the characteristics of the information recording medium, the conditions of Jp≦Jstd, Mp≦Mstd, J_{J}≦Jstd0 and M_{M}≦Mstd0 are used. More specifically, when these conditions are fulfilled, the characteristics of the information recording medium are determined to be satisfactory. The performance of the information recording medium can be efficiently evaluated from the point of view of margin, and thus the degree of freedom of developing mediums and apparatuses can be improved.

The prescribed values (e.g., Jstd) in the above example may be set in accordance with the recording capacity or the layer structure of the information recording medium. In the above example, the optimum position P_{best} is calculated using the jitter index J and the PRML error index M, and the index values are determined at the optimum position P_{best}. The determinations not limited to be performed on the indices for which the optimum position has been determined, but may be performed on other indices including, for example, modification degree, degree of asymmetry, CN ratio (carrier to noise ratio), and error rate.

In the case where the recording or reproduction parameter can be obtained in advance by the recording or reproduction apparatus, for example, in the case where the recording or reproduction parameter is recorded in the control track of the information recording medium, it is not necessary that the recording or reproduction parameter used for detecting the jitter index J is of the same type as the recording or reproduction parameter used for detecting the PRML error index M. Alternatively, the following information recording medium is usable: a minimum value Jmin of the jitter index which is detected by setting the optimum recording or reproduction parameter for the jitter index, a minimum value Mmin of the PRML error index which is detected by setting the optimum recording or reproduction parameter for the PRML error index, respectively fulfill prescribed values Jstd and Mstd. Since different recording or reproduction parameters can be set between the jitter index and the PRML error index, the degree of freedom of developing information recording mediums can be improved. Since the recording or reproduction parameter is recorded on the information recording medium, a value close to the optimum value can be obtained in advance. Therefore, the recording or reproduction parameter can be quickly optimized based on the information which is read from the information recording medium.

According to an apparatus and method of the present invention, a first optimum value of the recording or reproduction parameter is calculated based on there liability of the maximum likelihood decoding, and a second optimum value of the recording or reproduction parameter is calculated based on the jitter, and the value of the recording or reproduction parameter is set at a value between the first optimum value and the second optimum value inclusive. Thus, a recording or reproduction parameter which is optimum to both the maximum likelihood decoding and jitter can be derived.

According to an apparatus and method of the present invention, the recording or reproduction parameter is set such that the jitter is minimum. In addition, the recording or reproduction parameter at which the error generation probability is minimum when performing decoding using the maximum likelihood decoding method is set. A recording or reproduction parameter X1 and a recording or reproduction parameters X2 which are optimum for two types of evaluation indices are obtained, and an average value of the recording or reproduction parameters X1 and X2 is calculated. Alternatively, a recording or reproduction parameter, at which a difference from the parameter X1 and a difference from the parameter X2 have a ratio of a:b (a and b are each an integer), may be calculated. Thus, the recording or reproduction parameter which is optimum for the entire system can be derived. The reproduction parameter control is, for example, servo control or frequency characteristic control of a waveform equalizer. The recording parameter control Is, for example, recording power control.

As described above, the present invention is especially useful for an apparatus and method for controlling recording or reproduction, an apparatus for performing recording or reproduction, and an information recording medium identification apparatus.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An apparatus for controlling recording or reproduction, comprising:
a rectification section for receiving a digital signal generated based on an analog signal representing information reproduced from an information recording medium and a clock signal, and rectifying a waveform of the digital signal;
a maximum likelihood decoding section for performing maximum likelihood decoding of the digital signal having the waveform thereof rectified and generating a first binary signal representing a result of the maximum likelihood decoding;
a reliability calculating section for calculating a reliability of the result of the maximum likelihood decoding based on the digital signal having the waveform thereof rectified and the first binary signal;
a clock signal generation section for receiving a second binary signal generated by binarizing the analog signal based on a prescribed threshold value, detecting a phase error between the second binary signal and the clock signal, and adjusting a phase of the clock signal based on the detected phase error;
a jitter detection section for detecting jitter based on the detected phase error; and
a parameter setting section for setting a value of a prescribed parameter which is one of a recording parameter and a reproduction parameter;
wherein the parameter setting section calculates a first optimum value of the prescribed parameter based on the reliability, calculates a second optimum value of the prescribed parameter based on the jitter, and sets the value of the prescribed parameter between the first optimum value and the second optimum value inclusive.

2. An apparatus according to claim 1, wherein the prescribed parameter is a parameter used for performing at least one of tilt control, tracking control, focusing control, spherical aberration correction control, frequency characteristic control and laser power control,

3. An apparatus according to claim 1, wherein the parameter setting section sets the value of the prescribed parameter at an average value of the first optimum value and the second optimum value.

4. An apparatus according to claim 1, wherein the parameter setting section sets the value of the prescribed parameter at a value at which a difference from the first optimum value and a difference from the second optimum value have a prescribed ratio.

5. An apparatus according to claim 1, wherein the parameter setting section sets the value of the prescribed parameter, such that the value of the prescribed parameter is closer to an optimum value calculated based on either the reliability or the jitter, which is changed at a larger change ratio when the value of the prescribed parameter is changed, than to an optimum value calculated based on either the reliability or the jitter, which is changed at a smaller change ratio when the value of the prescribed parameter is changed.

6. An apparatus according to claim 1, wherein when a value of the jitter, which is obtained when the value of the prescribed parameter is the first optimum value, fulfills a prescribed condition, the parameter setting section Bets the value of the prescribed parameter at the first optimum value.

7. An apparatus according to claim 1, wherein when a value of the reliability, which is obtained when the value of the prescribed parameter is the second optimum value, fulfills a prescribed condition, the parameter setting section sets the value of the prescribed parameter at the second optimum value.

8. An apparatus according to claim 1, wherein the maximum likelihood decoding section performs maximum likelihood decoding using a state transition rule which is defined by a recording symbol having a minimum polarity inversion interval of 2 and an equalization system PR (C0,C1,C1,C0).

9. An apparatus according to claim 1, wherein the maximum likelihood decoding section performs maximum likelihood decoding using a state transition rule which is defined by a recording symbol having a minimum polarity inversion interval of 3 and an equalization system PR (C0,C1,C1,C0).

10. An apparatus according to claim 1, wherein the reliability calculation section calculates the reliability based on the digital signal corresponding to each of a start and an end of a recording mark formed on the information recording medium and the first binary signal.

11. An apparatus according to claim 1, wherein the first optimum value is a value of the prescribed parameter when the reliability is highest.

12. An apparatus according to claim 1, wherein the parameter setting section calculates the first optimum value based on one of an accumulation value and an average value of the reliability.

13. An apparatus for controlling recording or reproduction, comprising:
a parameter setting section for setting a value of a prescribed parameter which is one of a recording parameter and a reproduction parameter;
a first calculation section for receiving a digital signal generated based on an analog signal representing information reproduced from an information recording medium, and calculating a first index used for setting the value of the prescribed parameter based on the digital signal; and
a second calculation section for receiving a binary signal generated by binarizing the analog signal based on a prescribed threshold value, and calculating a second index used for setting the value of the prescribed parameter based on the binary signal;
wherein the parameter setting section calculates a first optimum value of the prescribed parameter based on the first index, calculates a second optimum value of the prescribed parameter based on the second index, and sets the value of the prescribed parameter between the first optimum value and the second optimum value inclusive.

14. An apparatus for performing recording or reproduction, comprising:
a reproduction section for generating a digital signal based on an analog signal representing information reproduced from an information recording medium and a clock signal;
a rectification section for rectifying a waveform of the digital signal;
a maximum likelihood decoding section for performing maximum likelihood decoding of the digital signal having the waveform thereof rectified and generating a first binary signal representing a result of the maximum likelihood decoding;
a reliability calculating section for calculating a reliability of the result of the maximum likelihood decoding based on the digital signal having the waveform thereof rectified and the first binary signal;
a clock signal generation section for receiving a second binary signal generated by binarizing the analog signal based on a prescribed threshold value, detecting a phase error between the second binary signal and the clock signal, and adjusting a phase of the clock signal based on the detected phase error;
a jitter detection section for detecting jitter based on the detected phase error;
a parameter setting section for setting a value of a prescribed parameter which is one of a recording parameter and a reproduction parameter; and
a head section for performing at least one of recording and reproduction of information based on the prescribed parameter;
wherein the parameter setting section calculates a first optimum value of the prescribed parameter based on the reliability, calculates a second optimum value of the prescribed parameter based on the jitter, and sets the value of the prescribed parameter between the first optimum value and the second optimum value inclusive.

15. An information recording medium identification apparatus, comprising:
a rectification section for receiving a digital signal generated based on an analog signal representing information reproduced from an information recording medium and a clock signal, and rectifying a waveform of the digital signal;
a maximum likelihood decoding section for performing maximum likelihood decoding of the digital signal having the waveform thereof rectified and generating a first binary signal representing a result of the maximum likelihood decoding;
a reliability calculating section for calculating a reliability of the result of the maximum likelihood decoding based on the digital signal having the waveform thereof rectified and the first binary signal;
a clock signal generation section for receiving a second binary signal generated by binarizing the analog signal based on a prescribed threshold value, detecting a phase error between the second binary signal and the clock signal, and adjusting a phase of the clock signal based on the detected phase error;
a jitter detection section for detecting jitter based on the detected phase error;
a parameter setting section for setting a value of a prescribed parameter which is one of a recording parameter and a reproduction parameter, wherein the parameter setting section calculates a first optimum value of the prescribed parameter based on the reliability, calculates a second optimum value of the prescribed parameter based on the jitter, and sets the value of the prescribed parameter between the first optimum value and the second optimum value inclusive; and
a determination section for determining whether or not the value of the reliability and the value of the jitter corresponding to the set value of the prescribed parameter fulfill a prescribed condition.

16. A method for controlling recording or reproduction, comprising the steps of:
receiving a digital signal generated based on an analog signal representing information reproduced from an information recording medium and a clock signal, and rectifying a waveform of the digital signal;
performing maximum likelihood decoding of the digital signal having the waveform thereof rectified and generating a first binary signal representing a result of the maximum likelihood decoding;
calculating a reliability of the result of the maximum likelihood decoding based on the digital signal having the waveform thereof rectified and the first binary signal;
receiving a second binary signal generated by binarizing the analog signal based on a prescribed threshold value, detecting a phase error between the second binary signal and the clock signal, and adjusting a phase of the clock signal based on the detected phase error;
detecting jitter based on the detected phase error; and
setting a value of a prescribed parameter which is one of a recording parameter and a reproduction parameter;
wherein the step of setting the value of the prescribed parameter includes the steps of calculating a first optimum value of the prescribed parameter based on the reliability, calculating a second optimum value of the prescribed parameter based on the jitter, and setting the value of the prescribed parameter between the first optimum value and the second optimum value inclusive.

17. A method according to claim 16, wherein the prescribed parameter is a parameter used for performing at least one of tilt control, tracking control, focusing control, spherical aberration correction control, frequency characteristic control and laser power control.

18. A method according to claim 16, wherein the step of setting the value of the prescribed parameter includes the step of setting the value of the prescribed parameter at an average value of the first optimum value and the second optimum value.

19. A method according to claim 16, wherein the step of setting the value of the prescribed parameter includes the step of setting the value of the prescribed parameter at a value at which a difference from the first optimum value and a difference from the second optimum value have a prescribed ratio.

20. A method according to claim 16, wherein the step of setting the value of the prescribed parameter includes the step of setting the value of the prescribed parameter, such that the value of the prescribed parameter is closer to an optimum value calculated based on either the reliability or the jitter, which is changed at a larger change ratio when the value of the prescribed parameter is changed, than to an optimum value calculated based on either the reliability or the jitter, which is changed at a smaller change ratio when the value of the prescribed parameter is changed.

21. A method according to claim 16, wherein the step of setting the value of the prescribed parameter includes the step of, when a value of the jitter, which is obtained when the value of the prescribed parameter is the first optimum value, fulfills a prescribed condition, setting the value of the prescribed parameter at the first optimum value.

22. A method according to claim 16, wherein the step of setting the value of the prescribed parameter includes the step of, when a value of the reliability, which is obtained when the value of the prescribed parameter is the second optimum value, fulfills a prescribed condition, setting the value of the prescribed parameter at the second optimum value.
